(19) United States
(12) Patent Application Publication
(10) Pub. No.: US 2010/0089520 A1
(43) Pub. Date: Apr. 15, 2010

(54) BLADDER, AN APPARATUS AND A METHOD FOR SHAPING AND CURING A TIRE

(75) Inventors: Peter Johann Cornelius Maus, Bulligen (BE); Laurent Licht, Zoufftgen (FR); Fahri Ozel, Eischen (LU)

Correspondence Address: DAVID L. KING, SR., 5131 N.E. COUNTY ROAD 340, HIGH SPRINGS, FL, 32643, US

(73) Assignee: THE GOODYEAR TIRE & RUBBER COMPANY, Akron, OH (US)

(21) Appl. No.: 12/250,006

(22) Filed: Oct. 13, 2008

(51) Int. Cl. B29D 30/30

(52) U.S. Cl. 156/131; 156/403

(57) ABSTRACT

A method, a bladder and an apparatus for shaping and curing a tire, wherein the bladder has two weakened regions corresponding to the shoulder regions of the tire when the bladder is expanded in the cavity of the tire. Upon inflation of the bladder and its expansion in the tire, the bladder contacts first the inner surface of the cavity at the bead regions and progressively the sidewalls, the shoulders and then the center of the tire. The weakened regions are designed to stretch more under a given tension than the remaining regions in order to allow a progressive contact movement of the lateral regions of the bladder with the sidewalls with very little tension and relative movement between the lateral regions of the bladder and the sidewalls of the tire.

### FIELD OF THE INVENTION

The present invention is directed to a tire bladder, an apparatus and a method for curing a tire.

### BACKGROUND OF THE INVENTION

In the manufacture of tire, the shaping of uncured tire carcasses also called green-tires by means of a machine comprising a mold and a bladder is generally known and an example is illustrated in FIG. 1. It shows a mold 3 composed of different movable elements for shaping and forming an uncured tire 1. To that end there is provided a bladder 2 shaped as an endless ribbon of elastomeric material, the two lateral edges 4 thereof being fastened to two circumferential flanges 5 and 6, respectively. The bladder 2 and the tire 1 are positioned such that the circumferential elastomeric ribbon is inside the toroid shape of the tire 1 and is facing the cavity of the tire. Upon inflation, the bladder 2 expands circumferentially into the tire cavity. The bladder contacts the whole inner surface of the tire and the internal pressure of the bladder exerts a pressure on the whole inner surface of the tire against the mold 3. The external surface of the tire is then pressed against the different elements of the mold for forming the sidewalls inscriptions and the tire tread. The tire 1 conforms thereby also to its final general shape. The mold and some other elements of the machine are heated up to a predetermined temperature in order to vulcanize the tire so that its rubber reaches a higher stiffness. Such a procedure, machine and bladder are known from example from US2006/0260735.

Uncured tire carcasses or green tires present a very low stiffness. The process of the bladder expanding in the tire cavity can cause relative movement between the outer contacting surface of the bladder and the inner surface of the uncured tire. This can lead to deformation and undesirable rubber flow of the tire. Indeed, the FIGS. 2a to 2f show cross sectional views of the bladder expansion and the molding procedure at different successive steps. FIGS. 2a to 2d show the progressive expansion of the bladder before it contacts the central section of the inner surface of the tire. In FIG. 2d, the bladder is already expanded a lot but still contacts only the bead regions 8 of the inner surface of the tire. This has for consequence that the high tensions in the bladder membrane resulting from its stretching are transmitted to the bead regions 8 of the sidewalls. These tensions can cause rubber flow or deformation of the green tire. In FIG. 2f the bladder finally contacts the shoulder regions 7 of the tire. At this stage, the tension in the membrane is further increased resulting in an increased risk of deformations in the sidewalls or bead areas.

Attempts to overcome these problems for low aspect tires have consisted in an increased thickness of the bladder membrane in the shoulder and lateral portions as disclosed in U.S. Pat. No. 7,144,236 B2. This solution nevertheless did not prove to be adapted for tires with a higher ratio like radial medium truck tires.

U.S. Pat. No. 3,963,394 discloses a bladder with a series of convolutions or expansion hollows extending circumferentially along the endless ribbon of the bladder and reinforcing material in the center and end sections of the bladder. These convolutions provide controlled amounts of extensibility to bladder whereas the reinforcing material limits the extensibility. The shape provided by these convolutions and reinforcements does not however reduce the deformation and undesirable rubber flow of the tire during curing as described here above.

### Definitions

“Axial” and “Axially” means the lines or directions that are parallel to the axis of rotation of a tire or a bladder.

“Bead” or “Bead Core” generally means that part of a tire comprising an annular tensile member of radially inner beads that are associated with holding the tire to the rim; the beads being wrapped by ply cords and shaped, with or without other reinforcement elements such as flippers, chippers, apexes or fillers, toe-guards and chafers.

“Circumferential” most often means circular lines or directions extending along the perimeter of the surface of the annular tread of a tire perpendicular to the axial direction; it can also refer to the direction of the sets of adjacent circular curves whose radii define the axial curvature of the tread, as viewed in cross section.

“Equatorial Plane” means the plane perpendicular to a tire's axis of rotation and passing through the center of its tread; or the plane containing the circumferential centerline of the tread.

“Gauge” refers to cross-sectional thickness, measured along a line that is normal to at least one surface of what is being measured.

“Lateral” means a direction parallel to the axial direction.

“Radial” and “radially” mean directions radially toward or away from the axis of rotation of a tire.

“Shoulder” of a tire means the upper portion of the tire sidewall just below the tread edge.

“Tread Cap” refers to the tread and the underlying material into which the tread pattern is molded.

“Tread Contour” means the shape of a tire tread as viewed in axial cross section.

“Tread width” means the arc length of the tread surface in the plane includes the axis of rotation of the tire.

### SUMMARY OF THE INVENTION

There is provided a bladder for shaping and curing a green tire comprising an endless ribbon of elastomeric membrane, the ribbon comprising a main circumferential portion which comes into contact with the cavity of the tire upon full inflation of the bladder and two circumferential edges which are adapted to be fastened to two axially opposite flanges of a tire mold, respectively; wherein the membrane of the main circumferential portion of the ribbon is structurally weakened in two circumferential strip-like regions, the rigidity of the membrane at the remaining regions of the main circumferential portion being higher than at the two structurally weakened circumferential strip-like regions, in such a way that the two structurally weakened circumferential strip-like regions are able, upon inflation of the bladder, to stretch substantially more than the remaining regions.

In one aspect of the invention, the two structurally weakened circumferential strip-like regions are located such that they come into contact with the shoulder portions of the tire when the bladder is fully inflated in the cavity of the tire.

In another aspect of the invention, the rigidity of the membrane at the remaining regions does not vary more than by 15%.

In yet another aspect of the invention, the gauge of the membrane at the two structurally weakened circumferential strip-like regions is less than at the remaining regions.

In yet another aspect of the invention, the gauge of the membrane at the two structurally weakened circumferential strip-like regions is less by at least 30% than at the remaining regions of the endless ribbon.

In yet another aspect of the invention, the gauge variation of the membrane when moving from the two structurally weakened circumferential strip-like regions towards a circumferential center region is continuous.

In yet another aspect of the invention, the gauge variation of the membrane when moving from the two structurally weakened circumferential strip-like regions towards the circumferential edges, respectively, is continuous.

In yet another aspect of the invention, at least one of the two structurally weakened circumferential strip-like regions comprises a first elastomeric material which is different from the elastomeric material used in the remaining regions and wherein the elasticity modulus of the first material is lower than the elasticity modulus of the elastomeric material used in the remaining regions.

In yet another aspect of the invention, the gauge of the membrane at the at least one of the two structurally weakened circumferential strip-like regions is less than at the remaining regions.

In yet another aspect of the invention, the elastomeric material used in the remaining regions is substantially homogenous.

There is also provided an apparatus for shaping and curing a green tire, comprising a tire mold comprising at least two axially opposite circumferential anchoring flanges; a tire bladder comprising an endless ribbon of elastomeric membrane, the ribbon comprising a main central circumferential portion which comes into contact with the cavity of the tire upon full inflation of the bladder and the two circumferential being fastened to the two axially opposite anchoring flanges, respectively; wherein the membrane of the main circumferential portion of the ribbon is structurally weakened in two circumferential strip-like regions, the rigidity of the membrane at the remaining regions of the main circumferential portion being higher than at the two structurally weakened circumferential strip-like regions, in such a way that the two structurally weakened circumferential strip-like regions are able, upon inflation of the bladder, to stretch substantially more than the remaining regions.

Finally, there is provided a method for shaping and curing a green tire, the method comprising the steps of providing a mold comprising a bladder, the bladder comprises an elastomeric membrane; putting a green tire into the mold, the tire comprising an inner surface forming a cavity; inflating the bladder so that the bladder expands in the cavity of the tire; curing said tire; wherein the elastomeric membrane of the bladder is weakened in those regions which come into contact with the shoulder portions of the tire cavity when the bladder is fully inflated in the tire cavity, the rigidity of the membrane in the regions coming into contact with the remaining portions of the tire cavity when the bladder is fully inflated being higher than at those regions coming into contact with the shoulder portions.

In one aspect of the invention, the inflation step, the bladder initially contacts the inner surface of the tire at inner bead regions of the tire and inner sidewalls regions of the tire and wherein the structurally weakened regions of the bladder are stretched during further inflation in such a way that the bladder then progressively come into contact with the inner shoulder regions of the tire and an inner central portion of the tire.

In another aspect of the invention, the weakened regions of the bladder are shaped in such a way that their stretching during inflation reduces or minimizes the deformation by stretching of side sections of the bladder contacting the inner sidewalls regions of said tire.

In yet another aspect of the invention, during the inflation step, the bladder contacts the inner surface of the tire progressively and symmetrically with regard to the equatorial plane EP of the tire.

In yet another aspect of the invention, a central region of the bladder located between the structurally weakened regions contacts the surface of the inner central region of the tire only when the shoulder regions of the bladder are already in contact with the inner shoulder regions of the tire.

### BRIEF DESCRIPTION OF THE DRAWINGS

The invention will be described by way of example and with reference to the accompanying drawings in which:

FIG. 1 is a sectional view of an apparatus for forming and curing tires as generally known from the prior art.

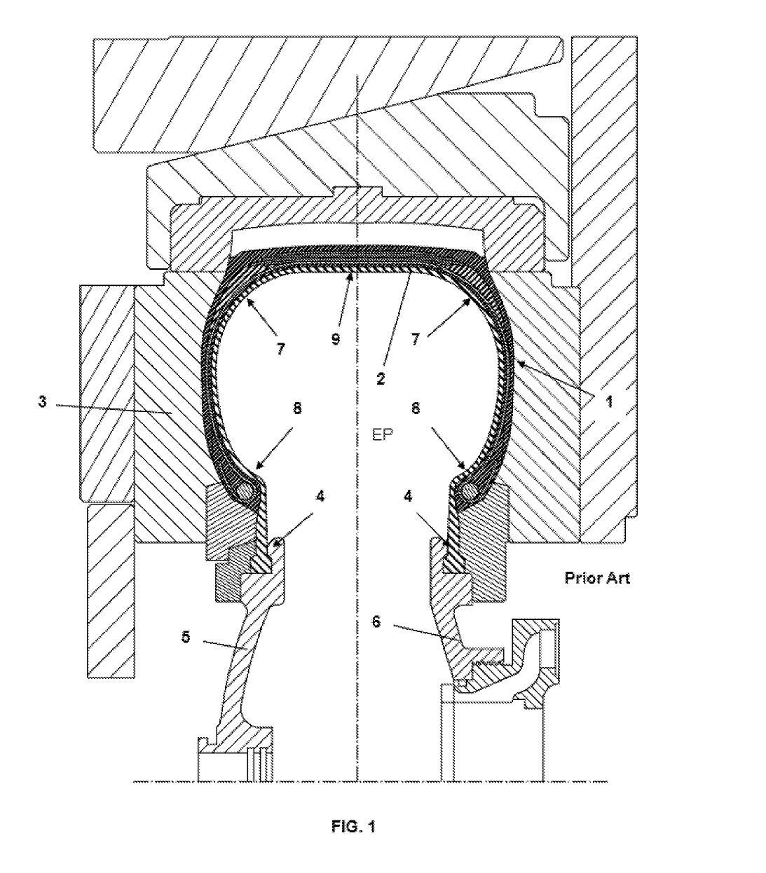

FIG. 2a to FIG. 2f are cross sectional views at successive different steps of the inflation and expansion process of a bladder according to the prior art.

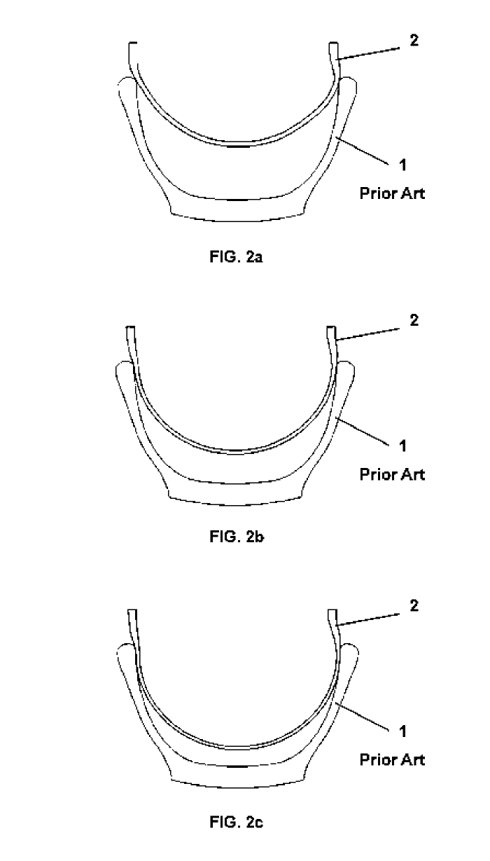

FIG. 3a to FIG. 3e are cross sectional views at successive different steps of the inflation and expansion process of a bladder according to the invention.

FIG. 3a shows the beginning of the inflation where the bladder comes into contact first with the lower sections of the inner sidewalls of a tire.

FIG. 3b, 3c, 3d and 3e show that the bladder comes progressively into contact with the inner sidewalls of the tire with a slight stretching of the corresponding portions of the bladder whereas the weakened regions are stretched to a greater extend.

FIG. 3f and 3g show that the contacting process of the bladder with the tire finishes with the center portion of the tire.

FIG. 4 is a sectional view of an apparatus for forming and curing tires according to the invention.

### DETAILED DESCRIPTION OF THE INVENTION

The following language is of the best presently contemplated mode or modes of carrying out the invention. This description is made for the purpose of illustrating the general principles of the invention and should not be taken in a limiting sense. The scope of the invention is best determined by reference to the appended claims. The reference numerals as depicted in the drawings are the same as those referred to in the specification.

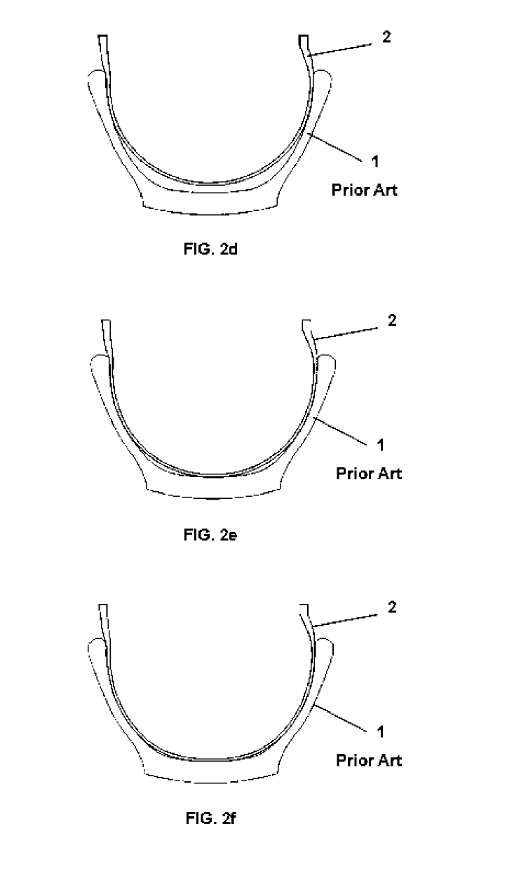

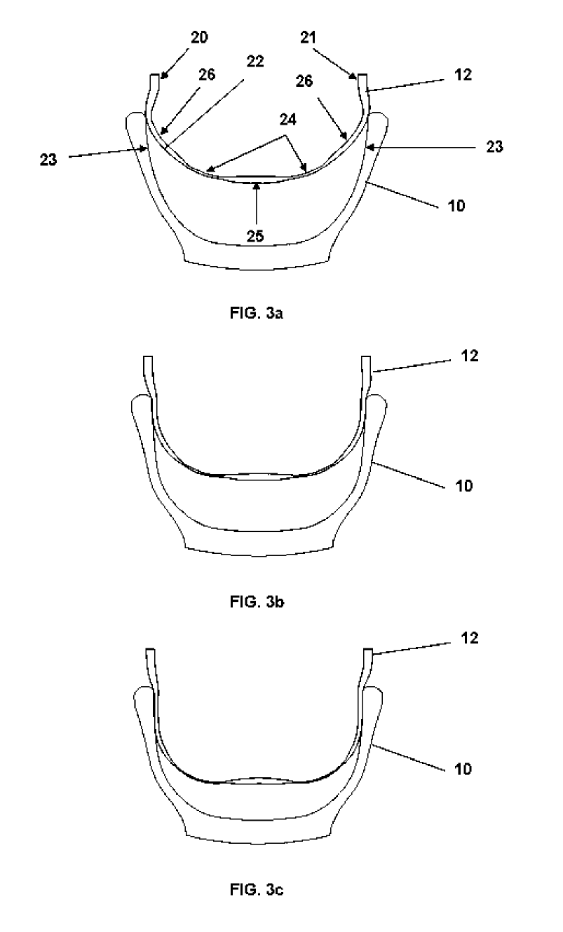

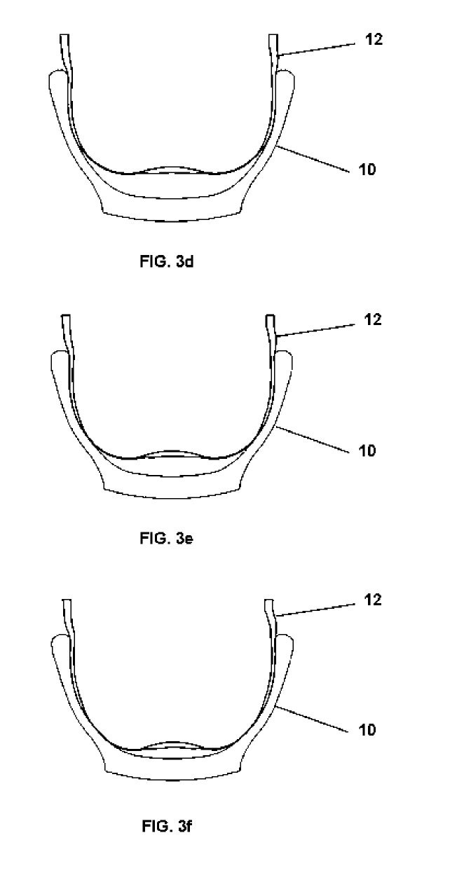

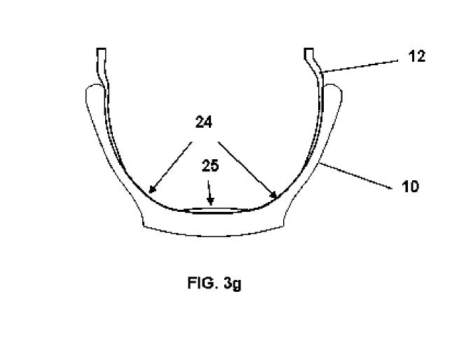

A best mode of carrying of the invention is illustrated in FIGS. 3a to 3g. FIG. 3a illustrates a bladder 12 in accordance with the invention in a partially inflated but not yet expanded state. The bladder 12 is composed of an endless ribbon or strip of elastomeric material forming an expandable elastomeric membrane 22. The ribbon comprises a main circumferential region 24, 25, 26 which comes into contact with the whole cavity of the tire upon inflation of the bladder and two circumferential edges 20, 21 which are adapted to be fastened to two axially opposite anchoring flanges of a tire mold. The gauge or thickness of the membrane 22 is not constant along the cross-sectional section of the bladder 12. The membrane 22 is thicker at the two circumferential edges 20, 21. This provides a higher stiffness and resistance at the anchoring regions. The thickness of the membrane initially diminishes progressively, i.e. continuously or gradually, from the edges 20, 21 to the lateral regions 26 contacting the inner lower sidewalls 23 of the tire. The membrane has a constant or essentially constant thickness in these lateral regions 26 of the bladder which contact the lower sidewalls 23 when the bladder is expanded. The membrane gauge then further diminishes progressively, i.e. continuously or gradually, from the lateral regions 26 to the shoulder regions 24, i.e. the regions of the membrane which come into contact with the inner surface of the tire at the shoulders regions when the bladder is fully inflated. As shown in FIGS. 3g, these shoulder regions 24 come into contact with the inner surface of the tire at the shoulder regions when the bladder is totally expanded in the tire cavity. The gauge of the membrane at the center region 25 located between the two structurally weakened regions 24 is about the same as the constant or essentially constant gauge of the lateral regions 26. In one embodiment, the gauge of the membrane in the weakened regions 24 is in the range of 30% to 70%, alternately 35% to 50% of the constant or essentially constant gauge of the membrane in the lateral regions 26. The membrane gauge can also vary continuously or gradually within the weakened regions 24 along the cross section of the membrane. The membrane does not vary by more than 15% gauge in the remaining regions which come into contact with the inner surface of the tire. The positions of the weakened regions 24 are preferably symmetrical with regard to the equatorial plane EP of the tire.

Upon progressive inflation of the bladder, it can been seen in FIG. 3b that the structurally weakened regions 24 are stretched more than the remaining regions of the membrane and that, as a consequence, the lateral regions 26 of the membrane come progressively and continuously into contact with the inner surface of the tire from the bead regions to the shoulder regions. This is illustrated in FIGS. 3b, 3c and 3d. It is noticeable that the membrane gauge at the lateral regions 26 does not substantially vary or, if any, very little so that the relative movement between the outer contacting surface of the bladder and the inner surface of the uncured tire is very limited.

Still upon further inflation of the bladder, the shoulder regions 24 of the membrane come progressively into contact with the inner surface of the tire following the lateral regions 26. This is illustrated in FIGS. 3e and 3f. The central region 25 of the bladder is now also under tension and slightly stretched, mainly at the connection areas with the structurally weakened regions 24. The central region 25 remains essentially parallel to the tread of the tire and approaches the corresponding inner surface portion of the tire progressively. As illustrated in FIGS. 3f and 3g the central region 25 of the membrane contacts the tire at the very end of the expansion process of the tire, i.e. after that the structurally weakened regions 24 have fully contacted the tire.

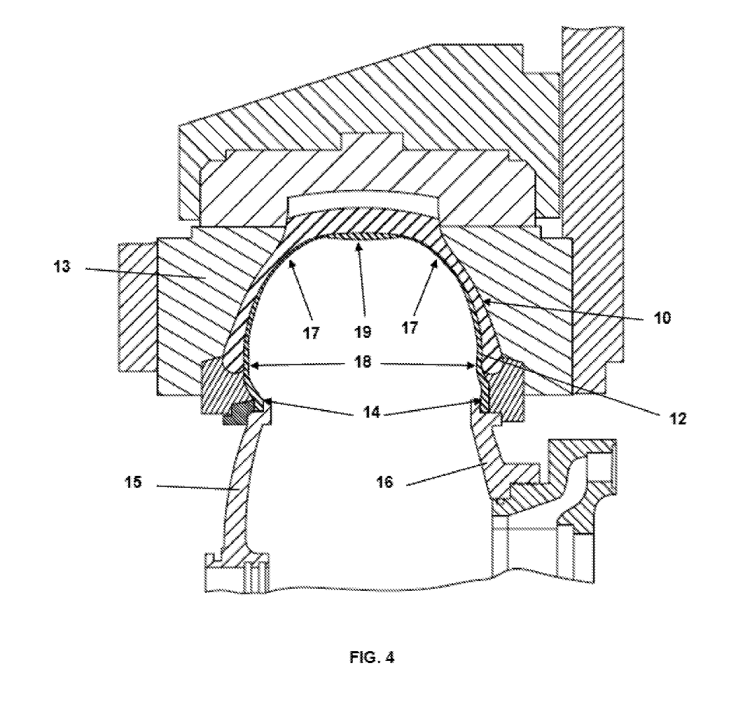

An apparatus for forming and curing tires involving a bladder as described in FIGS. 3a-3g is illustrated in FIG. 4. A tire 10 is positioned into a mold 13 and a bladder 12 is inflated in the cavity of the tire to come into contact with the whole inner surface of the tire. The two circumferential edges 14 of the membrane of the bladder 12 are fastened to two anchoring flanges 15 and 16, respectively. The bead regions of the inner surfaces of the tire are represented by the numeral 18, the shoulder regions by the numeral 17 and the center region by the numeral 19. The presence of structurally weakened regions 24 (FIG. 3g) at the shoulder regions of the membrane as recited here above permits a shaping of the bladder 12 during its inflation. This shaping allows a progressive contact of the bladder during inflation with the inner surface of the tire from the tire beads 18 to the inner center region 19 of the tire and reduces, if not avoids, any relative movement between the lateral regions 26 of the bladder 12 and the corresponding sidewalls of the tire. The stretching ability of the structurally weakened regions 24 of the membrane 22 reduces the stress in the lateral regions 26 of the membrane at the end of the expansion progress, i.e. when the membrane comes into contact with the shoulder and central regions of the tire. This is particularly true for tires which have normal or high aspect ratios.

The thickness variation of the bladder along its profile can be designed differently as illustrated here above. For example, the variations can be more progressive or more abrupt as illustrated. The exact bladder profile will depend on the characteristics of its material and also of the tire to be shaped and cured.

In addition, the gauge of the membrane can also be designed for influencing the temperature distribution along the tire profile during curing as a thinner gauge of the membrane results in a faster heating up of the corresponding tire portion being in contact with that part of the membrane. As can be seen in FIGS. 3a-3g, more particularly in FIG. 3g, the central region 25 of the membrane is less stretched than the rest of the membrane when fully inflated in the tire, so that the membrane gauge at this section can be set higher than at the lateral regions 26 in order to slow down the heating up of the center region of the tire.

The tire bladders of the present invention are formed by conventional expandable and durable materials, preferably rubber. The bladders may be reinforced with plies of parallel cord materials or woven fabrics. These features of a tire bladder are well known and conventional in the art of bladder forming.

In an alternative mode for carrying out the invention, the bladder 12 could be weakened at the shoulder portions 24 by using a different elastomeric material compared to the elastomeric material used in the other parts 25, 25 of the membrane. In this embodiment, the rubber compound composition is changed in the two shoulder regions in such a way that it confers to these regions a lower elasticity modulus and a capacity to be more stretched under a given tension compared to the remaining regions, in particular compared to the lateral regions 26.

In a further alternative mode, a combination of a variation of the elastomeric material and of the thickness of the membrane is used for providing structurally weakened shoulder regions.

The invention has been described with reference to a best mode. Obviously, modifications and alternations will occur to others upon a reading and understanding of this specification. It is intended to include all such modifications and alternations in so far as they come within the scope of the appended claims or the equivalents thereof.

What is claimed is:

1. A bladder for shaping and curing a green tire comprising an endless ribbon of elastomeric membrane, the ribbon comprising a main circumferential portion which comes into contact with the cavity of the tire upon full inflation of the bladder and two circumferential edges which are adapted to be fastened to two axially opposite flanges of a tire mold, respectively; wherein the membrane of the main circumferential portion of the ribbon is structurally weakened in two circumferential strip-like regions, the rigidity of the membrane at the remaining regions of the main circumferential portion being higher than at the two structurally weakened circumferential strip-like regions, in such a way that the two structurally weakened circumferential strip-like regions are able, upon inflation of the bladder, to stretch substantially more than the remaining regions.

2. A bladder according to claim 1, wherein the two structurally weakened circumferential strip-like regions are located such that they come into contact with the shoulder portions of the tire when the bladder is fully inflated in the cavity of the tire.

3. A bladder according to claim 1, wherein the rigidity of the membrane at the remaining regions does not vary more than by 15%.

4. A bladder according to claim 1, wherein the gauge of the membrane at the two structurally weakened circumferential strip-like regions is less than at the remaining regions.

5. A bladder according to claim 4, wherein the gauge of the membrane at the two structurally weakened circumferential strip-like regions is less by at least 30% than at the remaining regions.

6. A bladder according to claim 5, wherein the gauge variation of the membrane when moving from the two structurally weakened circumferential strip-like regions towards a circumferential center region is continuous.

7. A bladder according to claim 5, wherein the gauge variation of the membrane when moving from the two structurally weakened circumferential strip-like regions towards the circumferential edges, respectively, is continuous.

8. A bladder according to claim 1, wherein at least one of the two structurally weakened circumferential strip-like regions comprises a first elastomeric material which is different from the elastomeric material used in the remaining regions and wherein the elasticity modulus of the first material is lower than the elasticity modulus of the elastomeric material used in the remaining regions.

9. A bladder according to claim 8, wherein the gauge of the membrane at the at least one of the two structurally weakened circumferential strip-like regions is less than at the remaining regions.

10. A bladder according to claim 9, wherein the elastomeric material used in the remaining regions is substantially homogenous.

11. An apparatus for shaping and curing a green tire, comprising
a tire mold comprising at least two axially opposite circumferential anchoring flanges;
a tire bladder comprising an endless ribbon of elastomeric membrane, the ribbon comprising a main circumferential portion which comes into contact with the cavity of the tire upon full inflation of the bladder and two circumferential edges being fastened to the two axially opposite anchoring flanges, respectively;
wherein the membrane of the main circumferential portion of the ribbon is structurally weakened in two circumferential strip-like regions, the rigidity of the membrane at the remaining regions of the main circumferential portion being higher than at the two structurally weakened circumferential strip-like regions, in such a way that the two structurally weakened circumferential strip-like regions are able, upon inflation of the bladder, to stretch substantially more than the remaining regions.

12. An apparatus according to claim 11, wherein the two structurally weakened circumferential strip-like regions are located such that they come into contact with the shoulder portions of the tire when the bladder is fully inflated in the cavity of the tire.

13. An apparatus according to claim 11, wherein the rigidity of the membrane at the remaining regions does not vary more than by 15%.

14. An apparatus according to claim 11, wherein the gauge of the membrane at the two structurally weakened circumferential strip-like regions is less than at the remaining regions.

15. An apparatus according to claim 14, wherein the gauge of the membrane at the two structurally weakened circumferential strip-like regions is less by at least 30% than at the remaining regions.

16. A method for shaping and curing a green tire, the method comprising the steps of:
providing a mold comprising a bladder, the bladder comprises an elastomeric membrane;
putting a green tire into the mold, the tire comprising an inner surface forming a cavity;
inflating the bladder so that the bladder expands in the cavity of the tire; curing said tire;
wherein the elastomeric membrane of the bladder is weakened in those regions which come into contact with the shoulder portions of the tire cavity when the bladder is fully inflated in the tire cavity, the rigidity of the membrane in the regions coming into contact with the remaining portions of the tire cavity when the bladder is fully inflated being higher than at those regions coming into contact with the shoulder portions.

17. A method according to claim 16 wherein, during the inflation step, the bladder initially contacts the inner surface of the tire at inner bead regions of the tire and inner sidewalls regions of the tire and wherein the structurally weakened regions of the bladder are stretched during further inflation in such a way that the bladder then progressively comes into contact with the inner shoulder regions of the tire and an inner central portion of the tire.

18. A method according to claim 16 wherein the weakened regions of the bladder are shaped in such a way that their stretching during inflation reduces or minimizes the deformation by stretching of side sections of the bladder contacting the inner sidewalls regions of said tire.

19. A method according to claim 16 wherein, during the inflation step, the bladder contacts the inner surface of the tire progressively and symmetrically with regard to the equatorial plane EP of the tire.

20. A method according to claim 16 wherein a central region of the bladder located between the structurally weakened regions contacts the surface of the inner central region of the tire only when the shoulder regions of the bladder are already in contact with the inner shoulder regions of the tire.
